(19) United States
(12) Patent Application Publication
(10) Pub. No.: US 2009/0183096 A1
(43) Pub. Date: Jul. 16, 2009

(54) MODELING CONVERSATIONS IN ELECTRONIC MAIL SYSTEMS

(75) Inventors: James J. Edelen, Seattle, WA (US); Jorge Pereira, Seattle, WA (US); James C. Kleewein, Kirkland, WA (US); Marcus A. Leal, Kirkland, WA (US); Naresh Sundaram, Redmond, WA (US); Gautam Bhakar, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/013,730

(22) Filed: Jan. 14, 2008

(51) Int. Cl. G06F 3/048; G06F 7/08; G06F 17/30

(52) U.S. Cl. 715/764; 707/104.1; 707/E17.048

(57) ABSTRACT

Emails are modeled as conversations, which are stand-alone email artifacts distinct from conventional folders. Conversations are arranged to reference messages, to have properties and an existence of their own, and present messages to a user reflecting the relationships between the messages as part of a conversation. Emails aggregated under a conversation may be assigned conversation related attributes in addition to the distinct attributes of the conversation itself. Conversations may be processed specially based on their characteristics such as being muted, branched into sub-conversations, and the like.

### BACKGROUND

The conceptual data model used in most email systems is derived from a simple filing cabinet metaphor. Messages are ‘stored’ in a hierarchy of folders. Those folders can have distinct properties (e.g. name of the folder, size of the folder, who is allowed to manipulate that folder, and in what way) and are themselves ‘stored’ in a mailbox (a filing cabinet).

Moreover, exchanged message are treated in conventional email systems similar to regular mail. This data model can model single, standalone, one way communications effectively. However, increasingly email is no longer standalone, or simple one way communication. A given email is now often part of a large protracted “conversation”, an interrelated series of messages that, when viewed over time and in aggregate, more closely resembles an interactive discussion between people and groups.

While some indication of reply and/or forwarding relationship between messages may be provided in conventional systems, the user interfaces do not typically present the user a visually user-friendly representation of the messages in an email trail or conversation with their relationships.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to modeling emails as conversations that are stand-alone email artifacts distinct from conventional folders. Conversations are arranged to reference messages, to have properties and an existence of their own, and can coexist with folder, categories, and other existing email grouping metaphors. Emails aggregated under a conversation can be assigned conversation related attributes in addition to the attributes of the conversation itself. Conversations may be processed specially based on their characteristics such as being muted, branched into sub-conversations, and so on. According to some embodiments, actions on a particular conversation may be carried over to message belonging to that conversation or messages may be arranged to be immune from actions on their conversation such as delete actions.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates a conceptual diagram of exchanged emails like a conversation;

FIG. 2 illustrates an example user interface of an email application modeling emails as a conversation;

FIG. 3 is a screenshot of an example email application user interface displaying messages as part of a conversation;

FIG. 4 is another conceptual diagram illustrating a conversation's relationships with other aspects of an email application;

FIG. 5 is an example networked environment, where embodiments may be implemented;

FIG. 6 is a block diagram of an example computing operating environment, where embodiments may be implemented; and

FIG. 7 illustrates a logic flow diagram for a process of processing emails according to a conversation model.

### DETAILED DESCRIPTION

As briefly described above, emails can be modeled as a conversation in an email application allowing users to take advantage of enhanced representation of relationships between emails, conversational attributes, and so on. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process.

The term ‘message’ as used herein includes—in addition to regular email message—electronic mail system objects like invitations, meeting notifications, notifications of updates to meeting dates/times, messages that acknowledge receipt of messages or indicate a message has been received and read, messages that indicate a message has been received and discarded before being read, as well as a number of other artifacts that may appear to be part of how a human conversation may be modeled. For example, based on an email conversation one may schedule a meeting. The process of scheduling the meeting may involve multiple iterations of people accepting or rejecting the meeting proposal, as well proposing new times/dates/places. Some users may consider the invitation/accept/reject objects as “messages”—thereby part of the conversation—whereas other users may not.

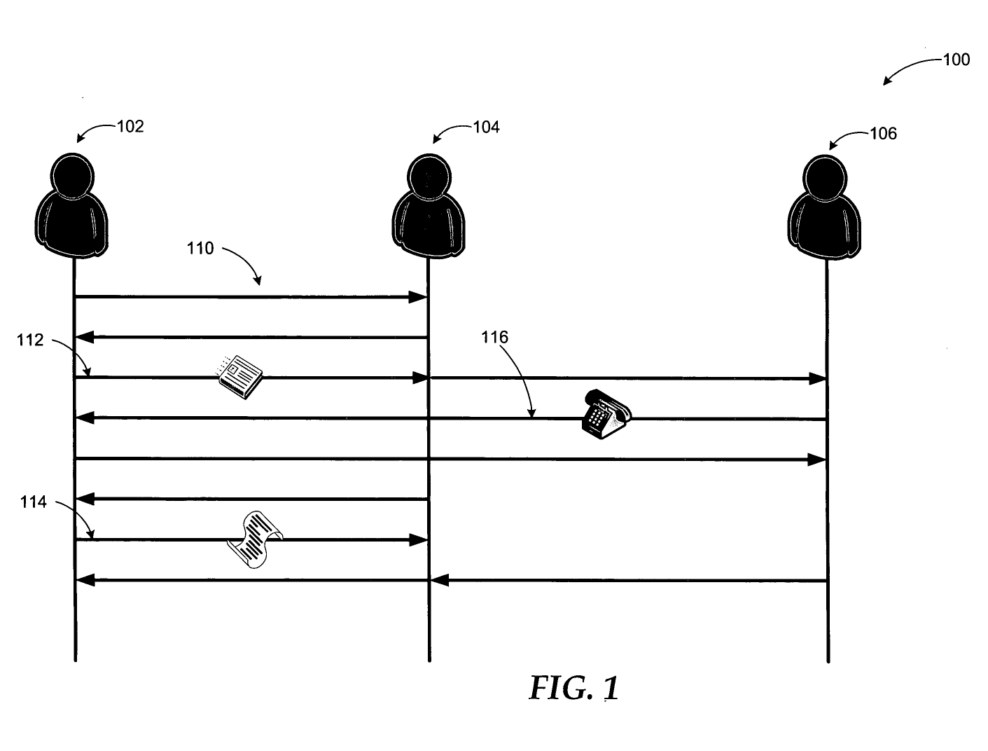

Referring to FIG. 1, a conceptual diagram of exchanged emails like a conversation is illustrated in diagram 100. Diagram 100 shows three users of an email system exchanging messages. The messages exchanged between users 102, 104, and 106 may include regular text-based messages (100), image or graphics documents 112, textual attachments 114, or audio messages 116. As shown in the diagram, the messages may be sent by one user to another or multiple others (e.g. user 102 to user 104 or users 104 and 106). Responses to the original message may be received from different parties, which themselves may be sent to all participants or to the originator. Thus, the exchanged messages may have a complicated structure, while all together representing a conversation among the participants (users 102, 104, 106).

In a system according to embodiments, not all messages that are part of the same conversation need to be stored in the same folder because the folder structure may group the messages differently. For example, a folder hierarchy may have a folder for claims made by an insurance client, and another for questions from that client. A conversation may be a claim followed by a series of questions. Furthermore, the conversation itself may have properties (e.g. a descriptive name for the conversation, the size of the conversation, annotations about the conversations such as if the conversation is complete, or a default folder to store messages for that conversation). Thus, a conversation may include messages from a single folder, multiple folders, and does not need to be a storage for its messages so that properties of that conversation can be preserved. As discussed below, a conversation may be implemented as an independent object within the email system along with its own attributes in addition to its email having their own attributes.

Conventional email systems typically do not allow messages to be stored in a folder and also be part of conversations that may span folders, where those conversations may have properties that are not necessarily properties of any message in that conversation, and the conversation can still exist even if all the messages in it have been deleted.

In a system according to embodiments, conversations may branch based on an explicit “action” performed by the user on a conversation which results is two independent conversations with the branched conversations having no messages in common. Thus, a message may belong only to one conversation.

According to other embodiments, however, messages may be part of multiple conversations at the same time when a conversation branches into several related conversations. Any message that is part of the shared history of those conversations may be effectively shared among the conversations. For example, a conversation that initially begins discussing email systems may branch into several distinct conversations on diverse topics such as spam, viruses, and networking technology. Any message in the original discussion about email is effectively an element of all the other conversations, or conversation branches.

According to other embodiments, a logic conversation object may be employed to organize messages as part of a conversation. The conversation object may be realized as a physical artifact or generated on demand. When a message is introduced into an email system, it may include an indication of which conversation (or conversation branch) it is a part of. According to further embodiments, a message's conversation may be determined through a variety of techniques, if that information is not directly provided by the message.

A conversation object may have associated properties, and it is a grouping or aggregation mechanism for messages. It is distinct, because the messages in the conversation have a specific order, that it not statically created by a user (like in a folder). The conversation object may also be automatically created whenever a message is introduced that is determined to not be an element of an existing conversation.

Some conventional email systems have categories for messages, but a conversation is distinct because a conversation is an inherent property of a message and is not directly set. An order of messages in a conversation is critical, conversations are not statically created, and conversations have properties that transcend the messages within a conversation. For example, a category may be a property of a conversation.

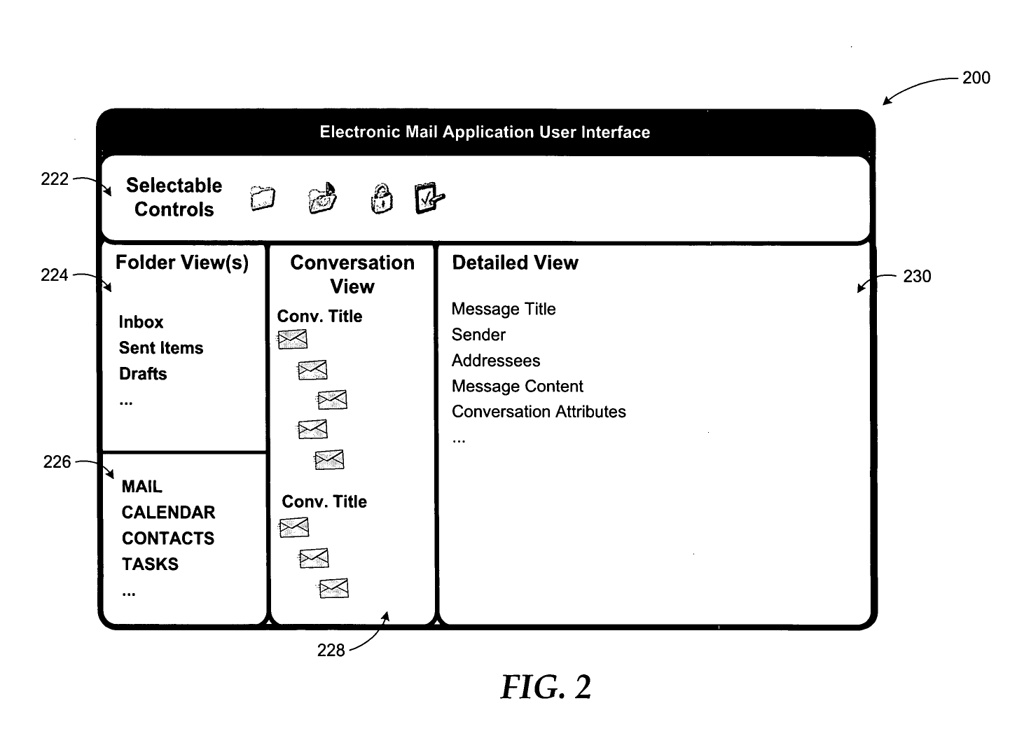

FIG. 2 illustrates an example user interface of an email application modeling emails as a conversation. Email user interface 200 is an example user interface for illustration purposes. Embodiments are not limited to the components and configuration of the example user interface.

Several aspects of an email system operate differently when conversation modeling according embodiments is employed. When a message is introduced, a conversation associated with the message is first identified. If the message does not explicitly identify the conversation it is part of, the information may be derived from the message (e.g. from a subject of the message). Any aggregated properties of the conversation affected by the introduction of the new message may then be updated. If the conversation associated with the message does not exist yet, a new conversation may be created and a default set of properties may be assigned. The new message is then assigned to the newly created conversation. The originator of the new message or an administrator may be provided with options to modify attributes and properties of the conversation (e.g. title, default folder, importance level, etc.).

When a message is removed, any aggregate properties of the conversation affected by the removal of a message may be updated. If the conversation object has no properties that require it to persist beyond the life of the final message in it, the conversation may also be removed following the removal of the final message in it, regardless of whether the conversation object is a physical object or a virtual object. When a message is updated, any aggregate properties of the conversation affected by the update of a message may be updated as well.

Conversations also introduce the ability to render a conversation as a single end-user artifact (a single display artifact) whenever a message in that conversation is opened. When a conversation opened, the conversation object opened, a list of associated messages and their order is retrieved, a folder (or folders, e.g. 224) in which those messages appear is determined. Any dynamically generated aggregate properties may then be computed and each of the messages of the conversation opened in reverse order (newest element of the conversation first). According to one embodiment, any duplicate information may be removed from the conversation, and the conversation rendered as a single display artifact (228).

If the user selects a particular conversation, the user interface (200) may begin displaying the conversation with the most recent message (e.g. the top message being displayed in detail view 230. If the user selects a particular message in the conversation, that message may be displayed in detail view 230. Optionally a relationship of the selected message to its parent (or the initial message) may also be displayed graphically using a color and/or geometric scheme.

In addition to the conversation related parts, the email user interface 200 may include standard components such as selectable controls (222), links to other functionalities (226) such as calendar. Selectable controls user interface 222 may include textually and/or graphically represented controls for standard operations as well as conversation-related operations such as filtering message within a conversation based on conversation properties or conversation-related message properties. Email user interface 200 may also include a pane for displaying a list of available conversations with their properties (muted, in order of their origination date, size, etc.).

An integral part of using conversation model for email applications is the fact that the conversation defines a set of logically related messages. This relationship may be defined in a number of ways. For example, messages may be associated by topic. Messages may be part of the same conversation if their topic property (the text that determines the subject or topic of the conversation) is the same. A machine learning algorithm may be employed to analyze subjects or topics of the messages. If simply words are compared over-grouping of the messages may result. On the other hand, expecting the exact same subject line or topic property from all messages to be aggregated under a conversation may result in related messages being left out of a conversation.

Another approach to associating messages within a conversation may be using an “in reply to” relationship. A group of messages of a conversation may be defined as the logical tree formed by a set of the replies, starting always with a single “new” message. In other words, the “in reply to” relationship used to determine the grouping can be defined as messages A and B belonging to the same conversation if they share at least one ancestor in the “in reply to tree.”

A further approach according to one embodiment is explicit definition of a conversation by a user (or administrator). Users may select conversations for a given message by a property (e.g. conversation ID), with any number of attributes, such as a color, a text, or a number. When a user sends out a message, he/she may explicitly set the conversation ID on the message (e.g. assign the message the red color). Any messages that are subsequent replies by other recipients may automatically carry the conversation ID (red), unless the recipient decides to change the property while sending the reply (thus logically “forking” the conversation to a different branch).

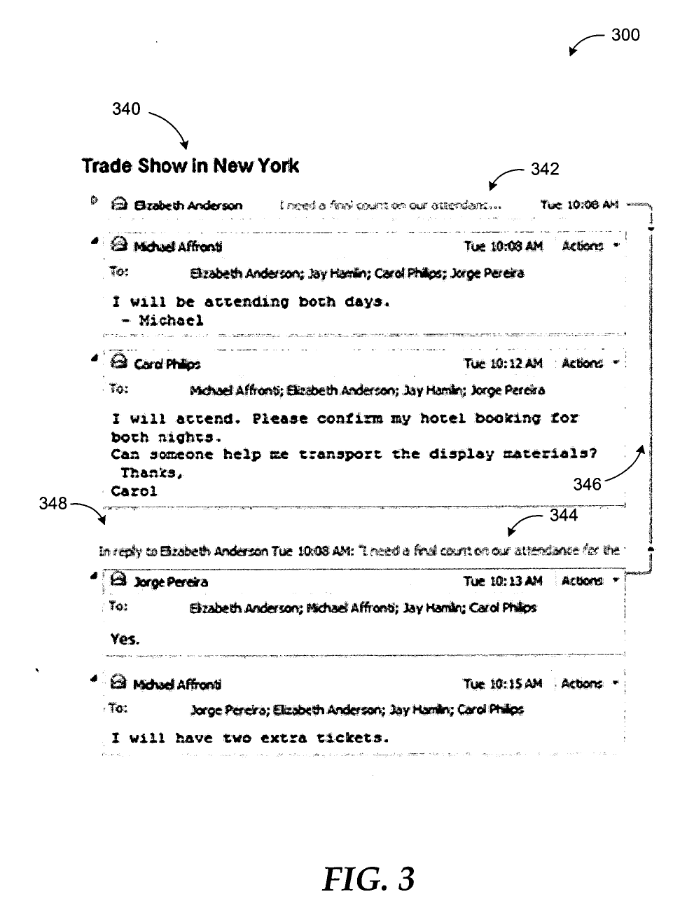

FIG. 3 is a screenshot of an example email application user interface displaying messages as part of a conversation. User interfaces displaying aggregated messages within conversations and their structure may be designed in various ways. Screenshot 300 is one such example user interface.

An important aspect of displaying messages within a conversation is the conversation's title 340, which may be explicitly provided by the originator of the first message creating the conversation or determined by the application from the initial email (e.g. a subject of the initial email). The originator may also be enabled to modify the title at any time (for example, in response to dynamically changing subject of the conversation).

Initial email 342 may be placed on top of the message list with the sender and a beginning portion of the message being displayed in a collapsed more (when the message is not selected by the user). As mentioned previously, conversations may have branches. Messages within a branch may be grouped together with the groups being separated by a space (348) or other means.

The second branch of the conversation begins with the first message of that branch (344) on top. According to some embodiments, a textual description of what the branch is may be provided at the top of the branch (e.g. “in reply to message . . . ”). While some user interfaces may provide a graphical representation of the relationships between the messages constantly (e.g. a tree structure), the example user interface displays the relationship between a selected message and its parent by connector 346. Various color and geometric schemes may be used to provide additional information about the relationships between the messages.

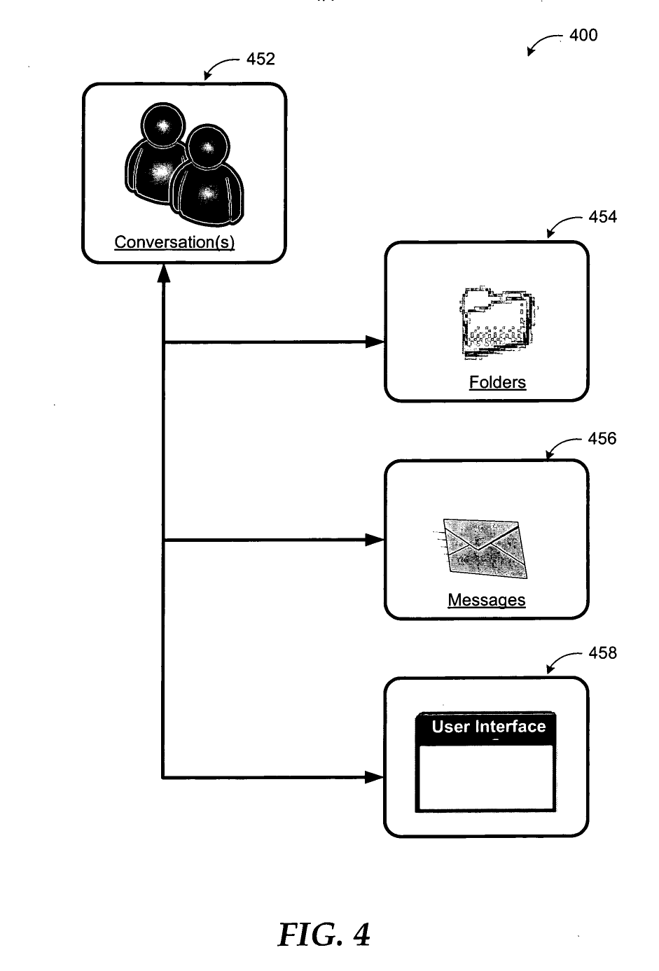

FIG. 4 is another conceptual diagram 400 illustrating a conversation's relationships with other aspects of an email application. An email application may have many aspects such as scheduling items, complementary user interfaces for presenting attachments (e.g. audio players, video players, image editors, etc.), and so on. Major aspects related to conversation are discussed here.

As a structured aggregation of messages, conversation 452 interacts with folders 454 of an email application, which provide categorized storage for the emails. As mentioned previously, conversation 452 may include messages from several folders. Conversation 452 is, of course, an aggregation of a subset of messages 456. It is created (or started) by a message that does not belong to an existing conversation and includes only messages that are related to each other by virtue of being part of a common exchange.

Conversation 452 also interacts with user interface 458 presenting the messages and their relationship so that a user can easily determine an order and a relationship of the messages among each other. Conversation properties as well as message properties may be presented to complement each other for a user-friendly display.

As mentioned previously, a conversation may have properties of its own (in addition to the properties of message within the conversation). Conversation properties may include any attribute that can be associated with a conversation. Some examples of conversation properties include a default folder name for the messages, a “mute” property (pushing the conversation to the background without eliminating it), a list of categories associated with the conversation, a number of messages within the conversation, a date and time of a first message initiating the conversation, a list of participants in the conversation, a total size of the messages within the conversation, and so on.

The described message aggregations, conversations, categories, components, properties, and scenarios in FIG. 1 through FIG. 4 are exemplary for illustration purposes. An email system employing conversation modeling may be implemented using additional or fewer components and features using the principles described herein. Other scenarios and communication types are also possible in a system like the one described here.

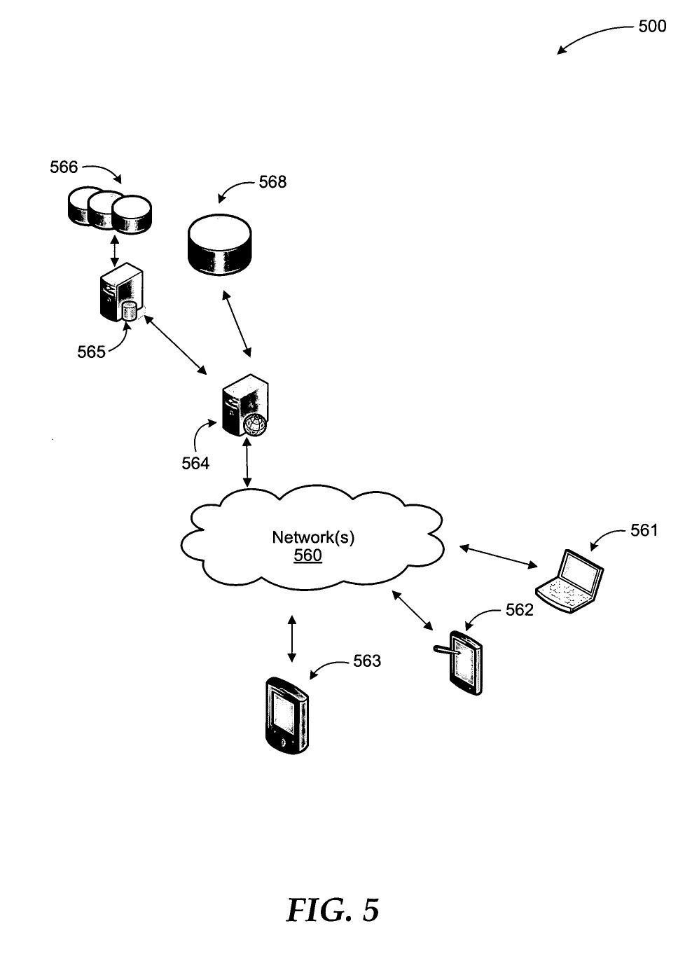

FIG. 5 is an example networked environment, where embodiments may be implemented. A system for facilitating email communications employing conversation modeling may be implemented locally on a single computing device or in a distributed manner over a number of physical and virtual clients and servers. The system may also be implemented in un-clustered systems or clustered systems employing a number of nodes communicating over network(s) 560.

Such a system may comprise any topology of servers, clients, Internet service providers, and communication media. Also, the system may have a static or dynamic topology. The term “client” may refer to a client application or a client device. While a networked system implementing conversation modeling for email may involve many more components, relevant ones are discussed in conjunction with this figure.

Email applications capable of modeling emails as conversations may be implemented in individual client devices 561-563 or executed on a server (e.g. server 564) and accessed from anyone of the client devices (or applications). In a hosted email service managed by one or more servers, messages and other data may be stored in system data stores such as data store 568 and accessed directly by the clients or in data stores 566 managed by database server 565.

Network(s) 560 may include a secure network such as an enterprise network or a cellular network, an unsecure network such as a wireless open network, or the Internet. Network(s) 560 provide communication between the nodes described herein. By way of example, and not limitation, network(s) 560 may include wired media such as a wired network or direct-wired connection, and wireless media such as acoustic, RF, infrared and other wireless media.

Many other configurations of computing devices, applications, data sources, data distribution systems may be employed to implement an email system according to embodiments. Furthermore, the networked environments discussed in FIG. 5 are for illustration purposes only. Embodiments are not limited to the example applications, modules, or processes.

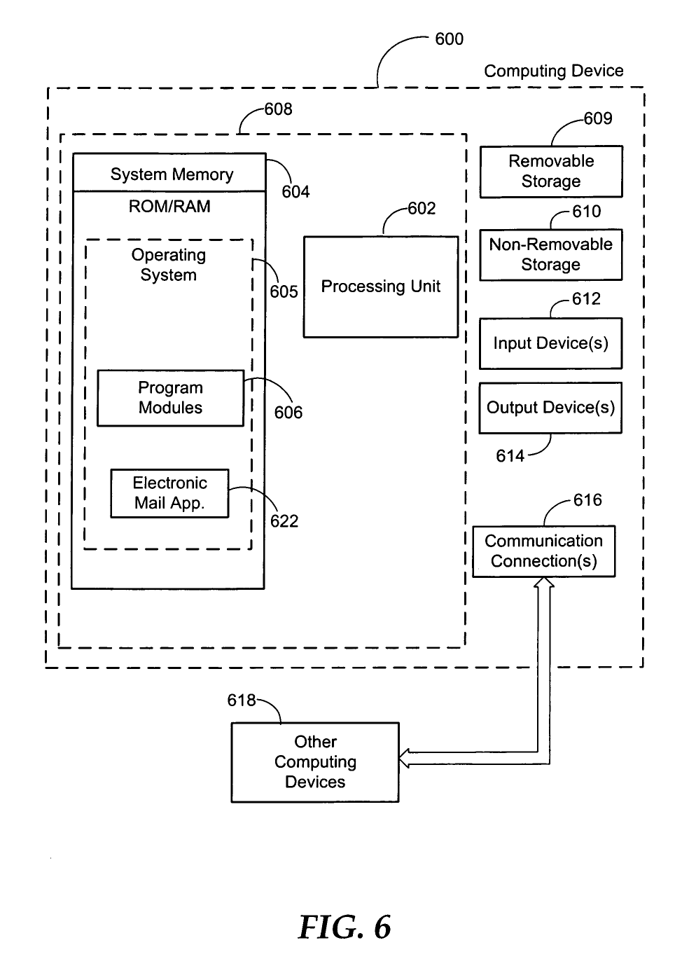

FIG. 6 and the associated discussion are intended to provide a brief, general description of a suitable computing environment in which embodiments may be implemented. With reference to FIG. 6, a block diagram of an example computing operating environment is illustrated, such as computing device 600. In a basic configuration, the computing device 600 may be a computer executing an email application and typically include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of a networked personal computer, such as the WINDOWS® operating systems from MICROSOFT CORPORATION of Redmond, Wash. The system memory 604 may also include one or more software applications such as program modules 606 and email application 622.

Email application 622 is configured to aggregate messages in conversations according to various approaches, as described previously. The conversation may persist and be rendered as a separate object with its own properties and created by a message that does not belong to any of the existing conversations. This basic configuration is illustrated in FIG. 6 by those components within dashed line 608.

The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 612 such as keyboard, mouse, pen, voice input device, touch input device, etc. Output device(s) 614 such as a display, speakers, printer, etc. may also be included. These devices are well known in the art and need not be discussed at length here.

The computing device 600 may also contain communication connections 616 that allow the device to communicate with other computing devices 618, such as over a wireless network in a distributed computing environment, for example, an intranet or the Internet. Other computing devices 618 may include server(s) that execute applications associated with a data access and directory service. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

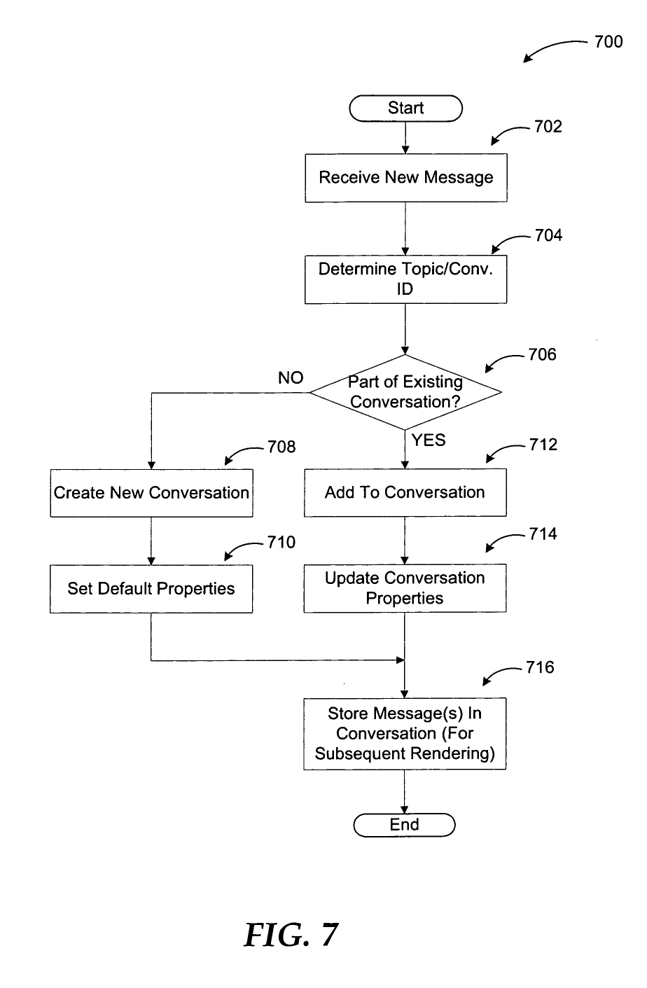

FIG. 7 illustrates a logic flow diagram for process 700 of processing emails according to a conversation model. Process 700 may be implemented in a local or distributed email application.

Process 700 begins with optional operation 702, where a new message is created by a user employing the email application. Processing advances from operation 702 to operation 704, where a topic or a conversation property (e.g. conversation ID) of the new message is determined by the application for classifying the message as belonging to a conversation. The user may explicitly define the topic or conversation property. Processing moves from operation 704 to decision operation 706.

At decision operation 706, a determination is made whether the new message is part of an existing conversation. If the message does not belong to any existing conversation, a new conversation is created at subsequent operation 708. After that, default properties are set for the newly created conversation in operation 710. A title of the new conversation may be derived from the new message. Processing moves from operation 710 to operation 716, where the messages are stored for subsequent rendering by an email application upon user demand. The storing and rendering of the messages is typically an asynchronous process using the conversation data according to embodiments.

If the new message is part of an existing conversation, the message is added to the determined conversation at operation 712. The properties of the conversation (and the message) are updated at subsequent operation 714 based on the added message. Processing then proceeds to operation 716, where the messages are rendered using conversation modeling in the email application's user interface too. After operation 716, processing moves to a calling process for further actions.

According to some embodiments one or more of the steps in modeling conversation in electronic mail systems may be asynchronous. For example, a message may be received at one time point (e.g. 3 am EDT), yet not referenced by a user of the email system until a later time point (e.g. 11 am EDT). While the system may have ‘received’ the message at 3 am, it may not have computed the conversation or rendered anything until 11 am when the email is referenced. Similarly, while the message may have been received and the conversation computed at 3 am the rendering need not occur until 11 am. The delayed computation may allow multiple messages to be classified into the same conversation at the same time—effectively amortizing some of the cost of computation over multiple messages.

The operations included in process 700 are for illustration purposes. Using conversation modeling in an email application may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing email communications employing conversation modeling, the method comprising:
receiving a new message;
determining a conversation property of the received message;
determining whether the received message is part of an existing conversation based on the determined conversation property of the message;
if the received message is part of an existing conversation:
associating the received message with the existing conversation; and
updating a conversation property based on the associated message;
if the received message is not part of an existing conversation:
creating a new conversation; and
setting default properties for the newly created conversation; and
storing the received message for subsequent rendering in an email application user interface as part of one of the new conversation and the existing conversation.

2. The method of claim 1, further comprising:
determining the conversation property of the message based on a least one from a set of: a message topic, an “in reply to” relationship of the message to another message, and an explicitly defined attribute of the message, wherein the conversation property is determined upon one of: receipt of the message and referencing of the received message by a user.

3. The method of claim 2, wherein the message topic is determined by one of: explicit user declaration and analysis by a machine learning algorithm.

4. The method of claim 2, wherein the explicitly defined attribute of the message includes a conversation identifier.

5. The method of claim 2, further comprising:
branching a conversation into a plurality of related conversations based on a change in the conversation property of a newly added message.

6. The method of claim 5, wherein any messages that are part of a shared history of the related conversations are shared among the related conversations.

7. The method of claim 1, wherein the conversation is associated with a plurality of properties that are applied to all messages within the conversation in addition to message-specific properties associated with individual messages.

8. The method of claim 7, wherein the plurality of properties associated with the conversation include at least one from a set of: a default folder name for the messages, a “mute” property (pushing the conversation to the background without eliminating it), a list of categories associated with the conversation, a descriptive name for the conversation, a status of the conversation, a number of messages within the conversation, a date and time of a first message initiating the conversation, a list of participants in the conversation, and a total size of the messages within the conversation.

9. The method of claim 8, wherein the status of the conversation includes one of: active, completed, and muted.

10. The method of claim 1, wherein the conversation includes messages stored in at least two distinct folders of the email application.

11. The method of claim 1, further comprising:
enabling the user of the email application to explicitly define the new message as part of the new conversation; and
enabling the user to modify at least one of the default properties associated with the new conversation.

12. The method of claim 1, further comprising:
in response to one of removal and update of a message within a conversation, updating any aggregate properties of the conversation.

13. A computing device capable of executing an email application for providing email communications employing conversation modeling, comprising:
a memory;
a data store;
a processor coupled to the memory and the data store, wherein the processor is configured to:
receive a new message;
determine a conversation property of the received message upon one of: receipt of the message and referencing of the received message by a user;
if the determined conversation property matches an existing conversation, associate the received message with the existing conversation and update any aggregated attributes of the existing conversation, wherein the existing conversation is implemented as an independent object; else
create a new conversation and set default properties for the newly created conversation; and
render the received message in a user interface of the email application by displaying relationships of messages as part of a conversation textually and graphically.

14. The computing device of claim 13, wherein the processor is further configured to:
update any aggregated attributes of a conversation in response to one of removal and update of a message associated with the conversation; and
remove the conversation in response to removal of a last message associated with the conversation.

15. The computing device of claim 13, wherein the processor is further configured to:
in response to receiving an indication to display a conversation within the email application user interface:
open the conversation object;
retrieve a list of associated messages, their order, and a list of folders storing the associated message;
retrieve the associated message from their respective folders; and
display the associated messages grouped under the conversation with any selected conversation attributes.

16. The computing device of claim 13, wherein the processor is further configured to:
in response to receiving an selection of a message within a conversation:
display the selected message in a detail view portion of the email application user interface; and
display graphically a relationship of the selected message to at least one of an original message of the conversation and a parent message of the selected message, wherein at least one of a color scheme and a geometric scheme are used to display the relationship.

17. A computer-readable storage medium with instructions stored thereon for providing email communications employing conversation modeling, the instructions comprising:
receiving a new message;
determining whether the received message is part of an existing conversation based on a least one from a set of: a message topic determined by heuristic analysis, an “in reply to” relationship of the message to another message, and an explicitly defined property of the message;
if the received message is part of an existing conversation, associating the received message with the existing conversation and updating any aggregated properties of the existing conversation;
if the received message is related to an existing conversation, but does not completely satisfy a predefined criterion for the existing conversation, creating a branch conversation related to the existing conversation and associating the received message with the branch conversation;
if the received message is not part of an existing conversation, creating a new conversation and setting default properties for the newly created conversation, wherein the conversations are implemented as independent objects within an email application capable of aggregating messages from distinct storage folders; and
rendering the received message in a user interface of the email application by displaying relationships of messages as part of a conversation textually and graphically.

18. The computer-readable storage medium of claim 17, wherein the instructions further comprise:
enabling one of an administrator and an author of a first message in the existing conversation to modify a name and at least one other property of the existing conversation, wherein the at least one other property includes a conversation status comprising one of: completed, muted, and active.

19. The computer-readable storage medium of claim 17, wherein the instructions further comprise:
including at least one other form of communication with the existing conversation.

20. The computer-readable storage medium of claim 19, wherein the other form of communication includes one of: an audio recording, an instant message, a video recording, an image, and a graphic.
